(19) United States
(12) Patent Application Publication
(10) Pub. No.: US 2019/0129349 A1
(43) Pub. Date: May 2, 2019

(54) IMAGE FORMING APPARATUS

(71) Applicant: CANON KABUSHIKI KAISHA, Tokyo (JP)

(72) Inventor: Junichiro Nakabayashi, Kashiwa-shi (JP)

(21) Appl. No.: 16/166,283

(22) Filed: Oct. 22, 2018

(30) Foreign Application Priority Data
Oct. 27, 2017 (JP) 2017-208169

(51) Int. Cl. G03G 15/00; G03G 15/20; G03G 15/16

(52) U.S. Cl. CPC G03G 15/70; G03G 15/1605; G03G 15/2028

(57) ABSTRACT

Disclosed is an image forming apparatus. The apparatus includes a transfer portion configured to transfer the toner image on an intermediate transfer member onto a sheet; a conveying portion configure to convey the sheet to a nip between the intermediate transfer member and the transfer portion; a fixing portion configured to fix the transferred toner image on the sheet; and a fixing motor configured to drive the fixing portion.

When a sheet jam occurs and when a sheet nipped by the conveying portion, the nip and the fixing portion is not a jam factor sheet, the intermediate transfer portion and the transfer portion are brought from a contact state into a separation state, the fixing motor is stopped after the intermediate transfer member and the transfer portion are separated, and the fixing motor is driven in order to convey the sheet after the sheet jam is recovered.

### BACKGROUND OF THE INVENTION

### Field of the Invention

The present invention relates to a sheet conveying apparatus whose conveying portion nips and conveys a sheet, and also relates to an image forming apparatus for facilitating the discharging of a sheet after sheet conveying is stopped.

### Description of the Related Art

In an image forming apparatus such as a copying machine, when a sheet is jammed in the apparatus due to some cause, it is necessary for the user to remove the sheets remaining in the apparatus. Particularly, when a jam occurs downstream of the sheet conveying path during continuous conveyance of a plurality of sheets, a sheet positioned upstream of the jam occurrence position cannot be discharged as long as the sheet which has caused the jam (jam factor sheet) exits. Thus, all the sheets remain in the apparatus. Therefore, in order to recover the jam, all those sheets have to be removed, which is a burden to a user. For resolving this, there is proposed a technique of automatically discharging the remaining sheets at the time when the user removes the jam factor sheet.

For example, in Japanese Laid-Open Patent Application No. H4-338050, an area in which it is difficult to automatically discharge a sheet in a conveying path is defined as an automatic removal difficult portion, and the apparatus is controlled such that a sheet does not stop at the automatic removal difficult portion when a jam occurs, thereby facilitating automatic sheet discharge.

In the configuration in which a sheet is nipped and conveyed by a roller pair, when the conveyance is stopped, by stopping the drive of the motor, thereby stopping the rotation of the roller pair. At this time, in the case where a sheet is nipped and conveyed by a plurality of roller pairs with different falling rotation speeds, i.e., different time periods from when the driving of the motor is stopped to when the rotation of the roller pair actually stops, when the drives for these roller pairs are stopped at the same time, the amount of feeding the sheet of the roller pair with slow falling speed is larger than that of the roller pair with fast falling speed.

Therefore, in the case where a sheet is nipped and conveyed across a plurality of roller pairs, when the falling speed of the roller pair on the upstream side is slower than that of the roller pair on the downstream side, the sheet is conveyed by the roller pair on the upstream side even after the roller pair on the downstream side stops sheet conveyance. As a result, the sheet stops in a buckling state. When the sheet conveyance is restarted for automatic sheet discharge from this state, for example, there is a high possibility that a jam occurs.

### SUMMARY OF THE INVENTION

An image forming apparatus according to the present invention, comprising:

an image forming unit configured to form a toner image on a photosensitive body;

an intermediate transfer member on which the toner image on the photosensitive body is transferred;

a transfer portion configured to transfer the toner image on the intermediate transfer member onto a sheet;

a conveying portion configured to convey the sheet to a nip between the intermediate transfer member and the transfer portion;

a fixing portion configured to fix the transferred toner image on the sheet;

a fixing motor configured to drive the fixing portion;

a contact and separation mechanism configured to bring the intermediate transfer member and the transfer portion into a contact state and into a separation state; and

a controller configured to control the fixing motor and the contact and separation mechanism,

wherein when a sheet jam occurs and when the sheet nipped by the conveying portion, the nip and the fixing portion is not a jam factor sheet, the controller controls the contact and separation mechanism so as to bring the intermediate transfer portion and the transfer portion from the contact state into the separation state, the controller stops the fixing motor after the intermediate transfer member and the transfer portion are separated, and the controller drives the fixing motor in order to convey the sheet after the sheet jam is recovered.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus.

FIG. 2 is a diagram showing driving sources of a secondary transfer portion and a fixing portion.

FIG. 3 is a diagram showing falling characteristics of a pressure roller and a secondary transfer roller.

FIG. 4A and FIG. 4B are a diagram for explaining a phenomenon that occurs when the pressure roller and the secondary transfer roller are stopped.

FIG. 5 is a control block diagram of the image forming apparatus.

FIG. 6 is a flowchart showing the process of the control portion in the first embodiment.

FIG. 7A and FIG. 7B are a diagram for explaining the movement of the toner image in the second embodiment.

FIG. 8 is a flowchart showing the process of the control portion in the second embodiment.

### DESCRIPTION OF THE EMBODIMENTS

Next, an image forming apparatus using a sheet conveying apparatus according to an embodiment of the present invention will be described.

### First Embodiment

<Overall Configuration of Image Forming Apparatus>

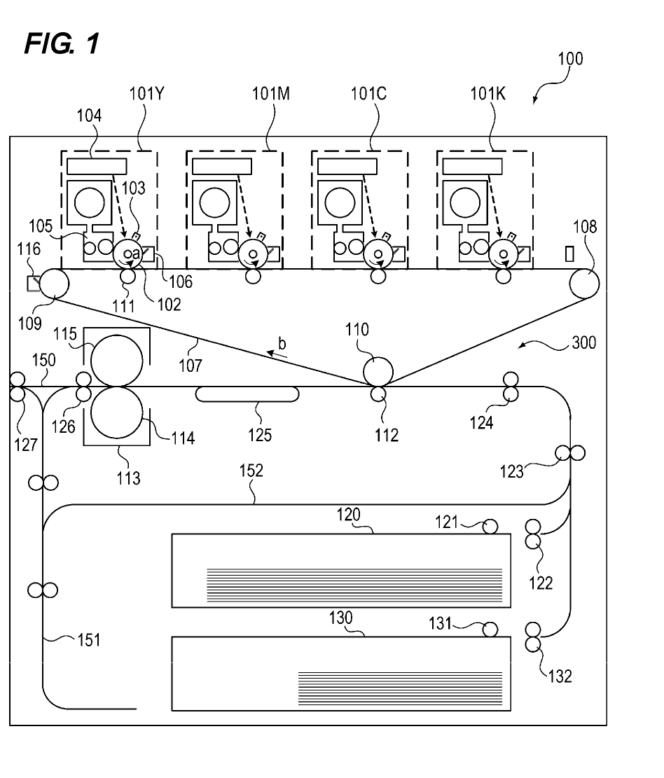

FIG. 1 is a diagram showing an example of the overall configuration of an image forming apparatus including a sheet conveying apparatus according to an embodiment of the present invention. The image forming apparatus 100 according to the present embodiment is an electro-photographic image forming apparatus that forms color images by transferring to a sheet the toner images formed by four electro-photographic image forming portions 101Y, 101M, 101C and 101K for forming images for respective colors using toners of yellow, magenta, cyan and black.

These image forming portions have the same configuration except for the color of the toner. The configuration of each image forming portion will be described by exemplifying the yellow image forming portion 101Y. The charging device 103, the exposure device 104, the developing device 105 and the cleaning device 106 are disposed around the photosensitive drum 102 as an image bearing member. Upon image formation, the peripheral surface of the photosensitive drum 102 rotating in the direction of the arrow a is charged by the charging device 103, and an electrostatic latent image is formed by light irradiation according to the image signal by the exposure device 104. Then, the electrostatic latent image is developed with toner by the developing device 105 to form a yellow toner image. Similarly, toner images of magenta, cyan and black are formed in the image forming portions 101M, 101C and 101K for magenta, cyan and black.

The intermediate transfer belt 107, which is a second image bearing member, is in contact with the photosensitive drum 102. The intermediate transfer belt 107 is an endless belt wound around the belt driving roller 108 and the driven rollers 109 and 110, and rotates in the direction of the arrow b by driving the belt driving roller 108 with a motor. Then, in each image forming portion, by applying the bias to the primary transfer roller 111, the toner image formed on the photosensitive drum 102 is sequentially transferred to the intermediate transfer belt to form a color image. The toner remaining on the photosensitive drum 102 after the toner is transferred to the intermediate transfer belt 107 is cleaned by the cleaning device 106.

In synchronism with the formation of the color image, the sheet is conveyed to the secondary transfer portion by the sheet conveying apparatus 300, and a transfer bias is applied to the secondary transfer roller 112 which is a transfer member, whereby the toner image on the intermediate transfer belt 107 is transferred to the sheet. The sheet is conveyed to the fixing portion 113 by the conveying belt 125 where the sheet is heated and pressurized to fix the toner image on the sheet. Thereafter, the sheet is discharged to the discharge portion (not shown) through the discharge path 150 by the discharge roller pairs 126 and 127. After the toner is transferred to the sheet P, the toner remaining on the intermediate transfer belt 107 is cleaned by the intermediate transfer belt cleaner 116.

It is possible for the image forming apparatus of this embodiment to perform double-sided recording of a sheet. When forming an image on the back side of a sheet as well, a sheet on which a toner image has been fixed on the front side is sent to the reverse path 151 and the sheet is switched back. Then, the sheet passes through the double-sided path 152, and the sheet is sent again to the secondary transfer portion.

<Sheet Conveying Apparatus>

In the sheet conveying apparatus 300, a sheet set in the feeding cassette 120 (or 130) disposed at the bottom of the apparatus body is conveyed by the conveying rollers 121, 122 (or 131, 132) and 123 and the registration roller 124, which are rotationally driven by the driving mechanism (not shown).

In the secondary transfer portion, the sheet is nipped together with the intermediate transfer belt 107 by the pair of rotating bodies (transfer rotating body pair) of the driven roller 110 and the secondary transfer roller 112 and is conveyed to the fixing portion 113. The fixing portion 113 has a pair of rotating bodies (fixing rotating body pair) of the pressure roller 114 and the fixing roller 115. While the sheet is being nipped and conveyed by both rollers, the sheet is heated and pressurized to fix the toner image on the sheet. Then, the sheet on which the toner image has been fixed is discharged by the discharge roller pairs 126 and 127.

(Driving Configuration for Sheet Conveying in Secondary Transfer Portion and Fixing Portion)

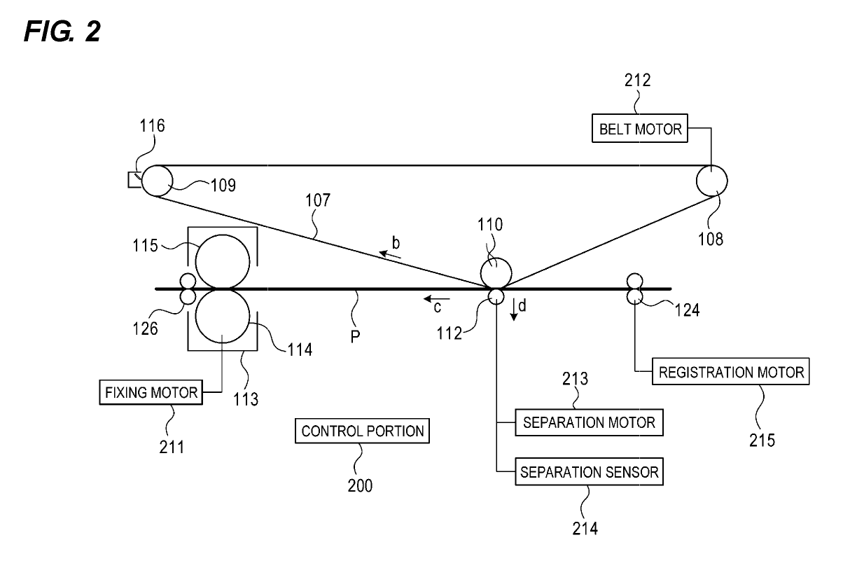

FIG. 2 is a diagram showing a driving configuration of the fixing portion and the secondary transfer portion. The fixing portion 113 serves as a conveying portion (first conveying portion) for nipping and conveying the sheet by the pair of rollers of the pressure roller 114 and the fixing roller 115. The pressure roller 114 is rotationally driven by the fixing motor 211, whereby the fixing roller 115 is driven to rotate. As a result, the sheet P is nipped and conveyed in the direction of the arrow c in the drawing.

In the upstream side of the fixing portion 113 in the sheet conveyance direction, the pair of rollers of the secondary transfer roller 112 and the driven roller 110 is configured as a conveying portion (second conveying portion) that nips and conveys the sheet. The sheet is conveyed in the conveying portion by the rotation of the intermediate transfer belt 107 and the driven rollers 109 and 110 as the belt driving roller 108 is rotationally driven by the belt motor 212. When the secondary transfer roller 112 is in contact with the driven roller 110 via the intermediate transfer belt 107, the secondary transfer roller 112 is driven to rotate similarly and the toner image formed on the intermediate transfer belt 107 is transferred to the sheet P while the sheet P is conveyed in the direction of the arrow c in the drawing.

The secondary transfer roller 112 of the present embodiment has a contact and separation mechanism driven by the separation motor 213 so that the secondary transfer roller 112 is configured to be in contact with and to be separated from the intermediate transfer belt 107. With this configuration, the sheet can be nipped between the secondary transfer roller 112 and the intermediate transfer belt 112 to convey the sheet, and also the nipping of the sheet can be released. Specifically, the secondary transfer roller 112 is configured to be movable in the direction of the arrow d in FIG. 2 as the separation motor 213 is driven from the state in which the sheet is nipped between the secondary transfer roller 112 and the intermediate transfer belt 107 whereby the contact and separation mechanism is operated. Namely, the secondary transfer roller 112 is configured to be capable of be in contact with and be separated from the driven roller 110 via the intermediate transfer belt 107. Whether or not the secondary transfer roller 112 is separated from the driven roller 110 can be detected by the separation sensor 214.

The conveying portion (third conveying portion) with a registration roller pair is disposed upstream of the conveying portion with the secondary transfer roller 112 in the sheet conveying direction. The registration roller 124 is rotationally driven by the registration motor 215 whereby the sheet P is conveyed in the direction of the arrow c in the drawing.

The drives of the respective motors such as the belt motor 212, the fixing motor 211, the separation motor 213 and the like are controlled by the control portion 200.

(Conveyance Stop Time at Each Conveying Portion)

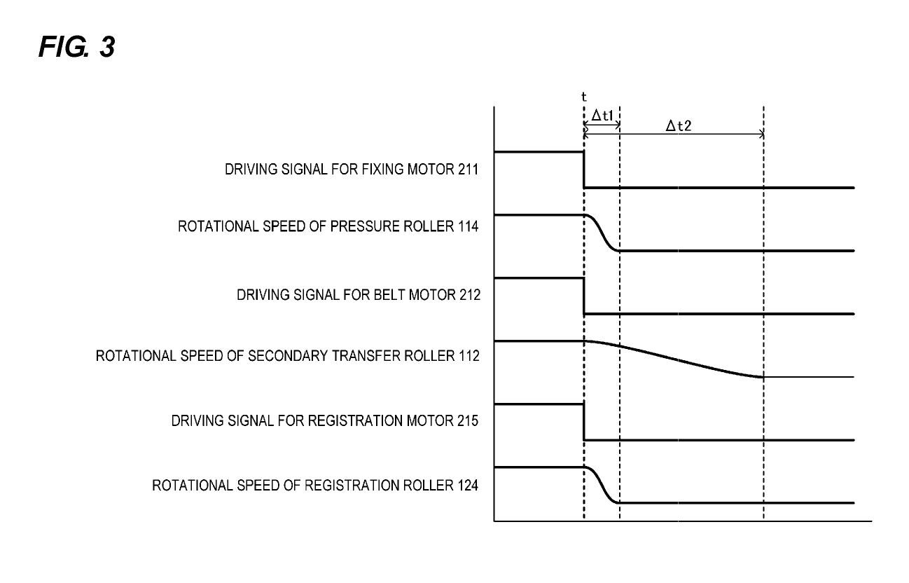

Next, referring to FIG. 3, the falling characteristics of the rotational speed when stopping the pressure roller 114, the secondary transfer roller 112 and the registration roller 124 of the present embodiment, i.e., the time from when generation of the conveyance stop signal to when the rollers actually stop (the time taken for stopping the conveyance of the sheet) will be described.

The time from when the driving of the fixing motor 211 is stopped at the time t to when the rotation of the pressure roller 114 is completely stopped is indicated by AU. Similarly, the time from when the belt motor 212 is stopped to when the secondary transfer roller 112 stops completely is indicated by Δt2.

In this embodiment, Δt1<Δt2. This means that it takes more time to stop the secondary transfer roller 112 than the pressure roller 114. Since the falling characteristic of the registration roller 124 is the same as that of the pressure roller 114, the time for stopping the rotation of the registration roller 124 is substantially the same as that of the pressure roller 114.

(Control for Stopping Conveyance when Conveyance Stop Time Periods are Different)

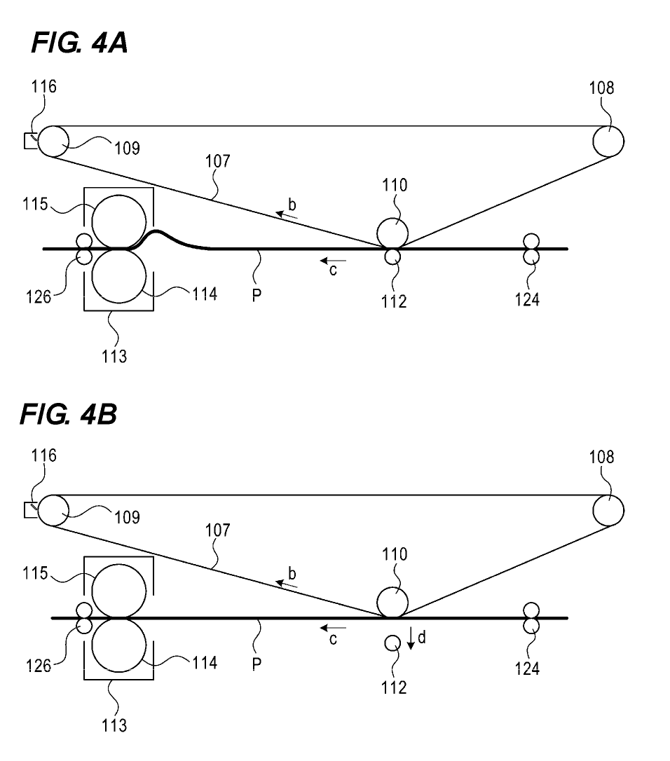

FIG. 4 is a diagram illustrating a phenomenon that occurs when the drives of the pressure roller 114, the secondary transfer roller 112 and the registration roller 124 are simultaneously stopped while the sheet P is being conveyed.

When a sheet jam occurs in the vicinity of the discharge port of the image forming apparatus 100 or in a post-processing apparatus connected downstream of the image forming apparatus 100, a sheet upstream of the jam factor sheet cannot be discharged, and the conveyance is stopped. Depending on the position and the length of the sheet, the sheet may be stopped in the state where the sheet is nipped by the three rollers of the pressure roller 114, the secondary transfer roller 112 and the registration roller 124.

When the fixing motor 211, the belt motor 212 and the registration motor 215 are stopped at the same time while the sheet is being nipped and conveyed by the above three rollers, the sheet P is in the state shown in FIG. 4A. As described above, the secondary transfer roller 112 is slower to stop than the pressure roller 114 and the registration roller 124. Therefore, even after the pressure roller 114 and the registration roller 124 are stopped, the secondary transfer roller 112 continues to convey the sheet for a while, and as a result, the sheet P buckles. When the apparatus is configured to automatically discharge the sheet stopped in the buckling state after the jam recovery, there is a high possibility that a jam occurs when the conveyance is resumed.

In order to resolve the above problem, in this embodiment, the apparatus is controlled so as to stop the fixing motor 211, the belt motor 212 and the registration motor 215 after separating the secondary transfer roller 112 from the driven roller 110. FIG. 4B is a diagram showing a state of the sheet P when the fixing motor 211, the belt motor 212, and the registration motor 215 are stopped after separating the secondary transfer roller 112 from the driven roller 110. When the sheet conveyance is stopped in the state where the sheet P is nipped and conveyed by the three rollers of the pressure roller 114, the secondary transfer roller 112 and the registration roller 124, the separation motor 213 is firstly driven, whereby the secondary transfer roller 112 is moved in the direction of the arrow d in the drawing to release the nipping of the sheet by the secondary transfer roller 112. Thereafter, the fixing motor 211, the belt motor 212 and the registration motor 215 are stopped.

Since the sheet transfer force is lost when the secondary transfer roller 112 is separated from the driven roller 110, the sheet P is conveyed by the pressure roller 114 and the registration roller 124. Therefore, the sheet can be stopped without buckling.

When the trailing edge of the sheet is located between the secondary transfer roller 112 and the registration roller 124 and the sheet is not nipped by the registration roller 124, even if buckling of the sheet occurs at the time of stopping the conveyance, the buckling of the sheet is eliminated by separating the secondary transfer roller 112 after the conveyance is stopped. Therefore, the present control is effective when using the sheet whose length is larger than the distance between the pressure roller 114 and the registration roller 124, whereby the sheet is easily nipped by the three rollers of the pressure roller 114, the secondary transfer roller 112 and the registration roller 124.

<Control Portion>

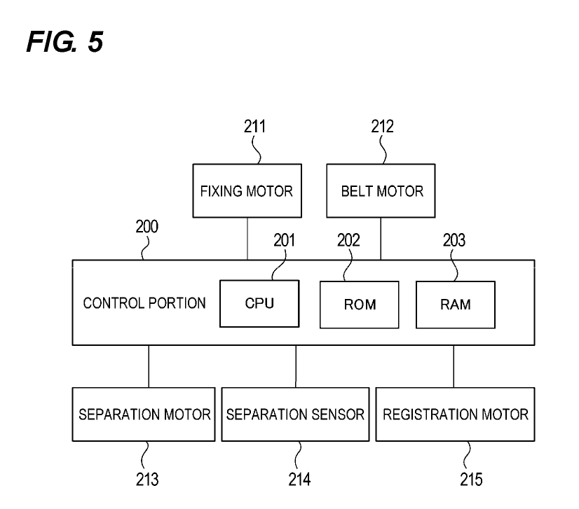

FIG. 5 is a block diagram of the control portion 200 of the image forming apparatus 100. The CPU 201 controls the image forming apparatus 100. A program for operating the CPU 201 is stored in the ROM 202. The RAM 203 is used for temporarily storing data by the CPU 201. These CPU 201, ROM 202 and RAM 203 are included in the control portion 200.

The fixing motor 211, the belt motor 212, the separation motor 213 and the registration motor 215 are connected to the control portion 200 and can be driven and stopped according to instructions from the CPU 201. The separation sensor 214 is also connected to the control portion 200, and it is possible to detect whether the secondary transfer roller 112 is in contact with or separated from the driven roller 110.

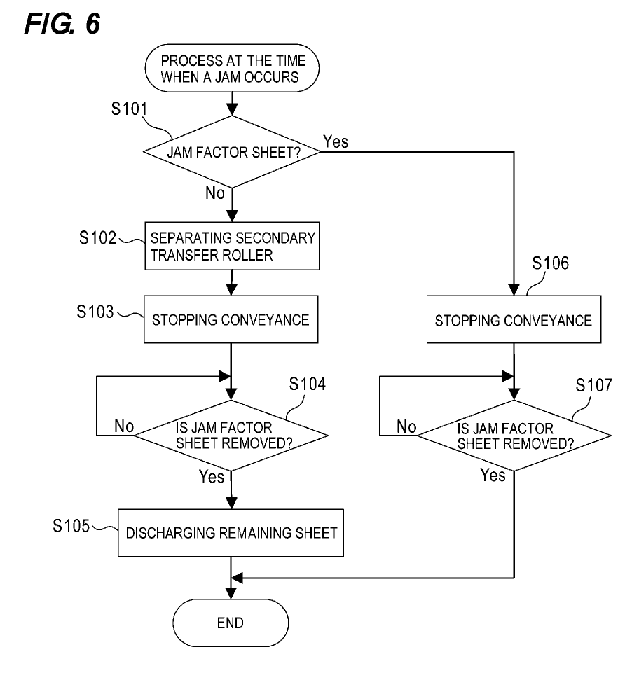

FIG. 6 is a flowchart showing the steps executed by the control portion 200 for stopping the sheet which is being conveyed by the pressure roller 114, the secondary transfer roller 112 and the registration roller 124 when a jam occurs in the present embodiment.

Firstly, the CPU 201 determines whether or not the currently conveyed sheet is a jam factor sheet (step S101). The sheet judged to be in the state where the sheet cannot be conveyed normally due to a sheet jam or the like is a jam factor sheet, and the other sheets are not a jam factor sheet.

When the conveyed sheet is a jam factor sheet, the CPU 201 immediately stops the driving of the fixing motor 211, the belt motor 212 and the registration motor 215, thereby stopping the conveying of the sheet (step S106). This is to prevent the difficulty of removing the sheet and to prevent the damage of the conveying portion due to deterioration of the state of sheet jam when the conveyance of the jam factor sheet is continued. Thereafter, the CPU 201 waits until the user removes the sheet (step S107), and ends the process.

On the other hand, when the conveyed sheet is not a jam factor sheet, the process advances to the step S102 where the CPU 201 drives the separation motor 213 to separate the secondary transfer roller 112 from the driven roller 110. The CPU 201 determines whether or not the separation of the secondary transfer roller 112 has been completed based on the signal from the separation sensor 214. At the time when the separation is completed, the fixing motor 211, the belt motor 212 and the registration motor 215 are stopped, thereby stopping the conveyance of the sheet (step S103).

Next, the CPU 201 waits until it is detected that the jam factor sheet has been removed (step S104). For detecting that the jam factor sheet is removed, there is, for example, a method of deciding that the jam factor sheet is removed when the sensor that detected the existence of the jam factor sheet has no longer detected it after the door for processing the jammed sheet is opened or closed.

When it is detected that the jam factor sheet has been removed, the process advances to the step S105 where the CPU 201 drives the fixing motor 211, the registration motor 215 and other motors for conveying the sheet, and performs automatic discharge operation of a remaining sheet. Since the secondary transfer roller 112 is separated at this time, it is not necessary to drive the belt motor 212.

As described above, the sheet is stopped without buckling when the sheet jam occurs, and the possibility of occurrence of sheet jam can be reduced when performing automatic discharge. In the above process, after the sheet is stopped and after the jam factor sheet is removed, the sheet is discharged automatically at the step S105. However, the user may remove the sheet stopped by the operations of the steps S102 and S103.

The process in FIG. 6 may be modified as follows. Between the step S101 and the step S102 in FIG. 6, the CPU 201 determines whether or not the jam factor sheet is on the downstream side of the sheet that is being conveyed by the pressure roller 114, the secondary transfer roller 112 and the registration roller 124. When it is determined that the jam factor sheet is not on the downstream side of the sheet that is being conveyed, the CPU 201 continues to convey the sheet in order to discharge the sheet which is being conveyed. On the other hand, when it is determined that the jam factor sheet is on the downstream side of the sheet that is being conveyed, the process advances to the step S102. When the sheet is not nipped by the registration roller 124 since the trailing edge of the sheet is between the secondary transfer roller 112 and the registration roller 124, even if buckling of the sheet occurs at the time when the conveyance is stopped, the buckling of the sheet is eliminated by separating the secondary transfer roller 112 after the conveyance is stopped.

Thus, between the step of S101 and the step of S102 of FIG. 6, the CPU 201 determines whether the sheet which is being conveyed is not nipped by the registration roller 124 since the trailing edge of the conveyed sheet is between the secondary transfer roller 112 and the registration roller 124. If this judgement is “YES”, the process of the step S103 is performed, then the process of the step S102 is performed, and then the process of the step S104 is performed. On the other hand, if this judgement is “NO”, the process of the step S102 is performed, then the process of S103 is performed, and then the process of S104 is performed. The process after the step S104 is the same as that of FIG. 6.

### Second Embodiment

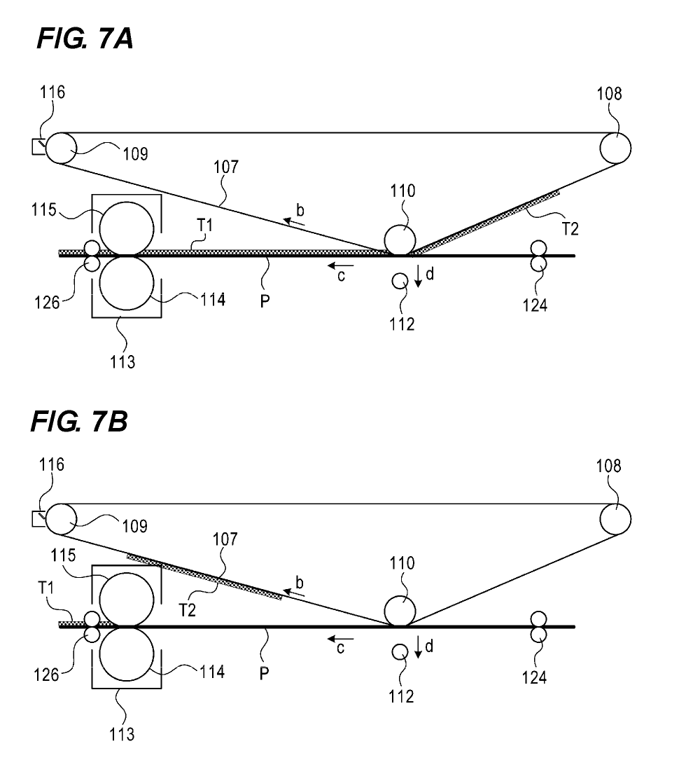

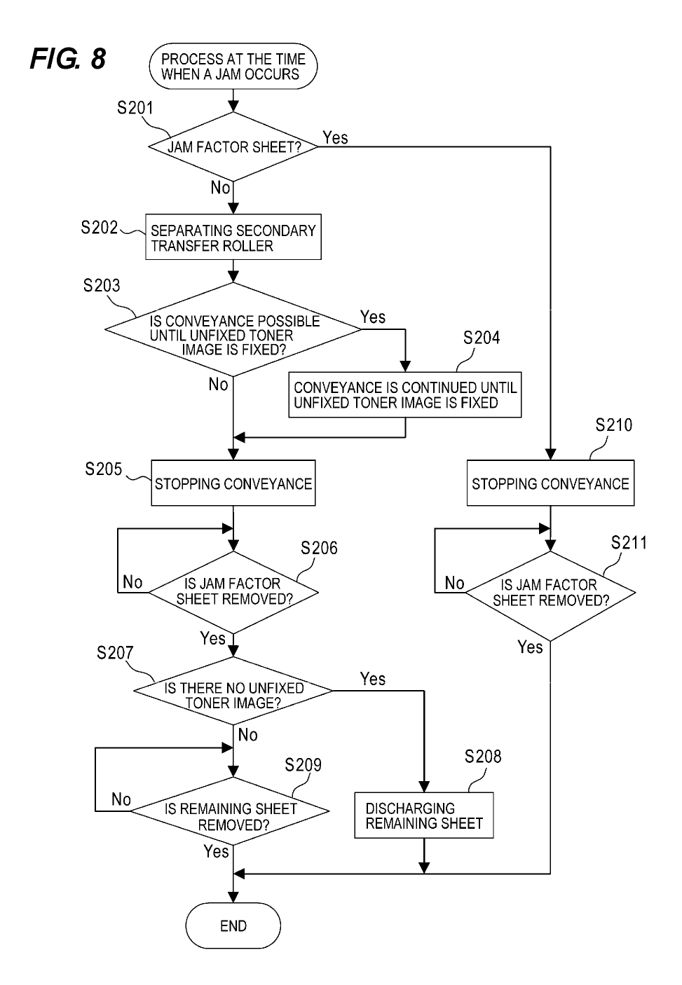

Next, the apparatus according to the second embodiment will be described with reference to FIGS. 7 and 8. Since the basic configuration of the apparatus of the present embodiment is the same as that of the above-described embodiment, duplicate explanation will be omitted, and the configuration that is the feature of this embodiment will be described here.

As in the above-described embodiment, when a jam or the like occurs, the sheet is stopped after the sheet nipping by the secondary transfer roller 112 is canceled. In addition to this operation, in the present embodiment, when there exists an unfixed toner image which is transferred on the sheet, the sheet conveyance is stopped after fixing this unfixed toner image.

FIG. 7A shows the state of the toner image when the secondary transfer roller 112 is separated to stop the conveyance of the sheet P, as in the first embodiment. The hatched portion indicates the toner image, T1 denotes the toner image already transferred to the sheet P, and T2 denotes the toner image which has not been transferred yet.

When the conveyance is stopped in the state of FIG. 7A, the toner image between the pressure roller 114 and the secondary transfer roller 112 out of the transferred toner image T1 has not been fixed yet. In order for the fixing unit 113 of the present embodiment to fix the toner image to the sheet, the advance preparation that the fixing roller 115 and the pressure roller 114 are sufficiently heated by a fixing heater (not shown) while rotating the pressure roller 114 is necessary. However, when conveying again the sheet stopped in the state nipped by the pressure roller 114, since the advance preparation cannot be performed, the toner image cannot be fixed. For this reason, when the sheet P stopped in the state of FIG. 7A is conveyed again for automatic discharge, unfixed toner will adhere to the rollers and the conveying path downstream of the pressure roller 114.

In order to avoid this, in the present embodiment, after separating the secondary transfer roller 112, the conveyance of the sheet is continued until the whole transferred unfixed toner image passes through the fixing portion 113, that is, until the unfixed toner image passes through the nip portion of the pressure roller 114 and the fixing roller 115, thereafter, the conveyance of the sheet is stopped.

FIG. 7B shows the state in which the conveyance of the sheet is continued until the whole transferred unfixed toner image passes through the nip portion between the pressure roller 114 and the fixing roller 115. Since the secondary transfer roller 112 is separated, the toner image T2 which has been transferred to the intermediate transfer belt 107 and has not yet been transferred to the sheet will not be transferred to the sheet P and will be conveyed to the intermediate transfer belt cleaner 116 by the intermediate transfer belt 107, where it is cleaned.

On the other hand, the whole toner image T1 already transferred to the sheet P passes through the nip portion between the pressure roller 114 and the fixing roller 115, and are fixed on the sheet P. By stopping the conveyance of the sheet P in this state, when the sheet P is conveyed again for automatic discharge, the whole toner image formed on the sheet P has already been fixed. Thus, the unfixed toner does not pollute the downstream rollers and conveyance path.

However, this control can be performed only when the sheet P does not collide with the preceding sheet even if the conveyance is continued until the unfixed toner image passes through the nip portion between the pressure roller 114 and the fixing roller 115. This control is performed when a sheet jam occurs downstream of the sheet P and the jam factor sheet must be immediately stopped. Thus, in this case, it is highly possible that the preceding sheet of the sheet P has been immediately stopped when a jam occurs. Therefore, when the preceding sheet is stopped at a position close to that of the sheet P in the same conveying path, this control cannot be performed.

Specifically, this control can be performed in the following cases.

Case (1): The distance from the rear end of the preceding sheet to the front end of the sheet P is larger than the distance from the nip portion between the secondary transfer roller 112 and the driven roller 110 to the nip portion between the pressure roller 114 and the fixing roller 115.

Case (2): The preceding sheet is directed to the reverse path 151 and the sheet P is directed to the discharge path 150 (including the opposite case).

Case (3): Both the preceding sheet and the sheet P are directed toward the discharge path 150 and the leading edge of the sheet P is at a position before branching to the reverse path 151 (including the case where both the preceding sheet and the sheet P are directed to the reverse path 151).

In the above case (3), since the collision with the preceding sheet can be avoided by feeding the sheet P to the reverse path 151, this control can be performed.

When the above conditions are not satisfied and the conveyance cannot be continued until the unfixed toner image passes through the nip portion between the pressure roller 114 and the fixing roller 115, the conveyance of the sheet P is stopped immediately after the secondary transfer roller 112 is separated. In order to prevent the unfixed toner from polluting the downstream rollers and the conveyance path, even if the jam factor sheet is removed, the automatic discharge processing for a remaining sheet is not performed. Since it is necessary for the user to remove a remaining sheet that have not been automatically discharged, the process such as notifying the user of the removal procedure is performed.

This control is effective when the sheet is nipped by the registration roller 124 even if the conveyance is continued until the unfixed toner image passes through the nip portion between the pressure roller 114 and the fixing roller 115. That is, it is effective when a long sheet is used.

FIG. 8 is a flowchart showing the steps executed by the CPU 201 for stopping the sheet which is being conveyed by the pressure roller 114, the secondary transfer roller 112, and the registration roller 124 when a jam occurs in the present embodiment. Since the steps S201 to S202 and S210 to S211 are the same as the steps S101 to S102 and S106 to S107 in the first embodiment, description thereof will be omitted.

After separating the secondary transfer roller 112, the CPU 201 determines whether it is possible to continue the conveyance until the unfixed portion of the toner image transferred onto the sheet passes through the nip portion between the pressure roller 114 and the fixing roller 115 (step S203). When any one of the cases (1) to (3) described above is satisfied, it is judged that conveyance can be continued.

When the conveyance can be continued, the conveyance is continued until the unfixed portion passes through the pressure roller 114 (step S204), and then the conveyance is stopped (step S205). When the conveyance cannot be continued, the conveyance is immediately stopped (step S205).

Next, the CPU 201 waits until it is detected that the jam factor sheet has been removed (step S206). Then, when it is detected that the jam factor sheet has been removed, the process advances to the step S207 where the CPU 201 judges the presence or absence of an unfixed toner image. When the unfixed toner image continues to be conveyed until it has passed through the nip portion between the pressure roller 114 and the fixing roller 115 in the step S204, it is determined that there is no unfixed toner image.

When there is no unfixed toner image, the process advances to the step S208 where the CPU 201 performs the automatic discharge operation for a remaining sheet by driving the fixing motor 211 and other motors for conveying a sheet. When there is an unfixed toner image, the CPU 201 waits until the user removes a remaining sheet without performing the automatic discharge operation for a remaining sheet (step S209). When the remaining sheet is removed from the inside of the image forming apparatus 100 by one of the above methods, the process is terminated.

By controlling the conveyance as described above, it is possible to convey the sheet again for automatic discharge after jam recovery without polluting the roller or the like with the unfixed toner transferred to the sheet. In the above, it is exemplified that the sheet is automatically discharged in the step S208. However, the sheet stopped at the fixing roller 115 can be removed by the user.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-208169, filed Oct. 27, 2017, which is hereby incorporated by reference herein in its entirety.

What is claimed is:

1. An image forming apparatus, comprising:
an image forming unit configured to form a toner image on a photosensitive body;
an intermediate transfer member on which the toner image on the photosensitive body is transferred;
a transfer portion configured to transfer the toner image on the intermediate transfer member onto a sheet;
a conveying portion configured to convey the sheet to a nip between the intermediate transfer member and the transfer portion;
a fixing portion configured to fix the transferred toner image on the sheet;
a fixing motor configured to drive the fixing portion;
a contact and separation mechanism configured to bring the intermediate transfer member and the transfer portion into a contact state and into a separation state; and
a controller configured to control the fixing motor and the contact and separation mechanism,
wherein when a sheet jam occurs and when the sheet nipped by the conveying portion, the nip and the fixing portion is not a jam factor sheet, the controller controls the contact and separation mechanism so as to bring the intermediate transfer portion and the transfer portion from the contact state into the separation state, the controller stops the fixing motor after the intermediate transfer member and the transfer portion are separated, and the controller drives the fixing motor in order to convey the sheet after the sheet jam is recovered.

2. The image forming apparatus according to claim 1,
wherein when a sheet jam occurs and when the sheet nipped by the conveying portion, the nip and the fixing portion is a jam factor sheet, the controller stops the fixing motor after the intermediate transfer member and the transfer portion are separated.

3. The image forming apparatus according to claim 1, further comprising:
a conveying motor configured to drive the conveying portion; and
an intermediate transfer member motor configure to drive the intermediate transfer member,
wherein the controller stops the fixing motor, the conveying motor and the intermediate transfer member motor after the intermediate transfer member and the transfer portion are separated.

4. The image forming apparatus according to claim 3,
wherein a time period taken for stopping the intermediate transfer member is longer than a time period taken for stopping the fixing motor.
